(19) United States
(12) Patent Application Publication
(10) Pub. No.: US 2017/0364492 A1
(43) Pub. Date: Dec. 21, 2017

(54) WEB CONTENT ENRICHMENT BASED ON MATCHING IMAGES TO TEXT

(71) Applicant: Machine Learning Works, LLC, San Francisco, CA (US)

(72) Inventors: Philipp Pushnyakov, Sochi (RU); Eugene Krokhalev, Sochi (RU); Dmitry Matov, Sochi (RU)

(21) Appl. No.: 15/187,687

(22) Filed: Jun. 20, 2016

(51) Int. Cl. G06F 17/22; G06K 9/46; G06F 17/30; G06K 9/00; G06T 11/60; G06K 9/62

(52) U.S. Cl. CPC G06F 17/2247; G06T 11/60; G06K 9/6262; G06K 9/6201; G06F 17/30247; G06K 9/00469; G06F 17/30864; G06F 17/3028; G06K 9/46

(57) ABSTRACT

A web content enrichment system can match an image to text of web content. When the text of web content includes a snippet, the image matched to the text enriches the snippet to enhance results of a search engine. When the text of web content includes text contained in a webpage, the image matched to this text enriches the webpage to enhance user perception and understanding of the webpage. The process of matching images to text involves extracting features of a plurality of images and features of a plurality of text documents, calculating scores of the images based on the extracted features, and selecting one image per text document based on the scores using a machine-learning algorithm. The result of the matching can be provided to a web content module for storing, incorporating into the result lists of the search engine, or delivery to a user.

### BACKGROUND

### Technical Field

This disclosure generally relates to digital image processing and web content processing. More particularly, this disclosure relates to methods and systems for enriching web content with images involving matching text of web content to images.

### Description of Related Art

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Web content includes any digital data from any private or public resource available on the Internet. Typically, web content includes webpages, web sites, files, multimedia content, and other documents that normally contain texts. Search engines can access webpages, rank and index them based on the texts of the webpages, thereby making the webpages searchable by users on the Internet.

A typical search result of a search engine includes, for example, a type of Uniform Resource Identifier (URI), such as a Uniform Resource Locator (URL), and a snippet of information for resources responsive to a search query. The snippet helps users or computing machines to identify, categorize, or describe web content such as the webpages. Unfortunately, the snippets today do not always effectively describe the webpages. Moreover, the webpages themselves do not effectively present written information to the users.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

This disclosure concerns methods and system for web content enrichment involving matching images to texts. An example method for web content enrichment comprises receiving a plurality of images by a feature extracting module, receiving a plurality of text documents by the feature extracting module, extracting image features from each of the images by the feature extracting module, extracting text features from each of the text document by the feature extracting module, matching the plurality of images to the plurality of text documents by an image matching module such that a set of the images is matched to a select text document of the plurality of text documents, calculating a score for each image of the set of the images by the image matching module, selecting the select image associated with the highest score, and enriching the select text document with the select image by a web content module.

Additional objects, advantages, and novel features of the examples will be set forth in part in the description that follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements.

FIG. 1 shows an example embodiment of a computer environment for implementing methods for web content enrichment.

FIG. 2 shows a block diagram of web content enrichment system, in accordance with an example embodiment.

FIG. 3 shows an example computing system that may be used to implement methods described herein.

FIG. 4 shows an example process for matching a plurality of images to a plurality of text documents.

FIG. 5 shows an example process for extracting text features from a text document.

FIG. 6 shows an example snippet (webpage) after enrichment.

FIG. 7 is a process flow diagram showing a method for web content enrichment.

### DETAILED DESCRIPTION OF EXAMPLE EMBODIMENTS

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

The present disclosure relates to methods and systems for matching images to text and using the image-to-text match information to enrich web content. For example, in some embodiments, a text of web content (e.g., text of a webpage) can be enriched with one or more images that are relevant to at least one part of the text. The images can represent one or more objects described in the text that help users to better perceive and understand the web content.

In other embodiments of this disclosure, the text that is matched to the image can refer to a snippet of a webpage. Thus, the image matched to the text can become part of the snippet of webpage, thereby enriching the snippet. Accordingly, when a user uses a search engine to produce search results for a certain search query, the results can include enriched snippets of webpages. Each of the enriched snippets can include, but not limited to, a webpage title, a webpage reference (e.g., a hyperlink, URI, URL, or Internet Protocol (IP) address), text (e.g., a brief description of the webpage), and the image that is matched to the text. The image can be provided as a thumbnail image near the text, thereby improving the perception of the snippet by the user.

According to certain embodiments of this disclosure, the image can be matched to text using a web content enrichment system that includes at least a feature extracting module and an image matching module. The feature extracting module receives a plurality of images and a plurality of text documents (e.g., snippets of webpages, texts contained in webpages, or information or description of webpages). The feature extracting module extracts features from both the images and the text documents and provides the features to the image matching module. The image matching module matches the images to the text documents based on their features and using one or more machine-learning algorithms, machine-learning algorithms, probabilistic algorithms, heuristic algorithms, neural network algorithms, and the like. In the process of matching, the image matching module can calculate scores of the images with respect to one or more of text documents based on the features of images and features of the text documents. Based on the scores, the image matching module can select one of the images per text document and provide a corresponding image-to-text classification result.

Furthermore, a web content module can enrich the text document according to the image-to-text classification result. For example, the web content module can enrich a snippet of a webpage with the image matched to the text of the snippet. The snippet can be used in producing a results list in a search of webpages performed by a search engine. In other embodiments, however, the web content module can enrich webpage itself with the image matched to the text of the webpage.

In yet further embodiments, the web content enrichment system can provide reverse functionality. For example, the web content enrichment system can receive a single query image. In response to receiving the query image, the web content enrichment system can retrieve features of the query image and optionally features of text documents associated with the query image, and produce a search query based on the features of query image and text documents. The search query can be then transmitted to the search engine in order to perform a search of webpages or other network accessible resources based on the search query.

The present embodiments of the invention may be implemented using a variety of technologies. For example, methods described herein can be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a transitory or non-transitory storage medium such as a disk drive or computer-readable medium. It should be noted that methods disclosed herein can be implemented by a computing device such as a server, desktop computer, tablet computer, laptop computer, general-purpose computer, network node, and so forth.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

It should be also understood that the terms “first,” “second,” “third,” and so forth can be used herein to describe various elements. These terms are used to distinguish one element from another, but not to imply a specific sequence of elements. For example, a first element can be termed a second element, and, similarly, a second element can be termed a first element, without departing from the scope of present teachings.

The term “web content” shall mean any information from any resource accessible via the Internet. The web content can include textual information, visual information, and audio information. Certain examples of web content include webpages and web sites. Some specific examples of web content include electronic documents, files, webpages, web sites, data objects, services, collections of resources, or generally anything that has an identifier and can be referenced in some manner on the Internet. Web content can be also referenced using, for example, URI, URL, hyperlinks, although it will be understood that various embodiments are not limited to using such addressing schemes.

The term “image” shall mean any type of digital data which has a two-dimensional or three-dimensional representation and displayable on a display of any electronic device. The images can have one or more attributes such as metadata, title, description, and so forth. Moreover, in certain embodiments, the term “image” can refer to a still image or a moving image (e.g., a video).

The term “text” shall mean any sequence of symbols, words, or phrases. In some embodiments, the term “text” can refer to one or more written words presented in any language. The term “text” can also refer to written information provided within web content (e.g., a webpage). The term “text” can also refer to written information provided in a snippet of webpage. In yet other embodiments, the term “text” can also refer to both written information provided within a webpage and written information provided in a snippet of the same webpage. In some embodiments, the term “text” and “text document” can be used interchangeably.

The term “snippet” can refer to a description of or an excerpt from a webpage. Thus, a snippet can include text (or text document). Generally, a snippet may include, but not limited to, a title (optionally), a reference, and a description/text of web content. For example, in some embodiments, a snippet includes (1) a description of or an excerpt from a webpage, and (2) a webpage reference (e.g., a hyperlink, cached link, URI, URL, or IP address). In other embodiments, a snippet includes (1) a description of or an excerpt from a webpage, (2) a webpage reference (e.g., a hyperlink, cached link, URI, URL, or IP address), and (3) a webpage title.

The term “enriched snipped” shall mean a snippet with an image matched according to embodiments of this disclosure. For example, an enriched snippet can include (1) a description of or an excerpt from a webpage, (2) a webpage reference (e.g., a hyperlink, cached link, URI, URL, or IP address), (3) a webpage title (optionally), and an image matched to the description of or the excerpt from the webpage.

The term “client device” can refer to a personal computer, laptop computer, tablet computer, smartphone, mobile phone, Internet phone, netbook, home gateway, broadband gateway, network appliance, set top box, television device, multimedia device, personal digital assistant, access gateway, network device, networking switch, network router, server computer, network storage computer, game console, entertainment system, infotainment system, vehicle computer, or any other computing device comprising at least a processor and network interface.

The term “web resource” shall mean any network addressable device including, but not limited to, any entity that can be identified, named, addressed, or handled in any networked information system, such as the Internet. The web resource can store and manage web content, such as webpages.

The term “search engine” shall mean any service entity capable of providing searches on a data communication network such as the Internet. In certain embodiments, the term “search engine” is used to refer to a hardware or software that can receive and process a search query to return a results list of URIs or URLs identifying one or more web content elements such as webpages. The search engine can include the index of documents and algorithms that determine the relevance of each searched document.

The term “search query” shall refer to one or more terms to be submitted to a search engine. In certain embodiments, a search query may include one or more symbols, one or more words, or phrases.

Referring now to the drawings, exemplary embodiments are described. The drawings are schematic illustrations of idealized example embodiments. Thus, the example embodiments discussed herein should not be understood as limited to the particular illustrations presented herein, rather these example embodiments can include deviations and differ from the illustrations presented herein as shall be evident for those skilled in the art.

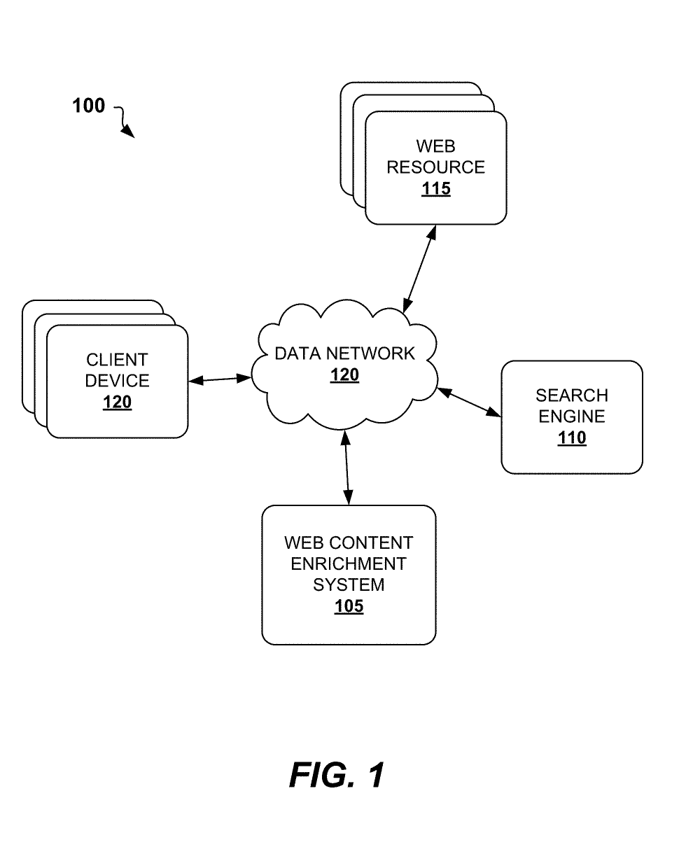

FIG. 1 shows an example embodiment of computer environment 100 for implementing methods for web content enrichment as described herein. The computer environment 100 includes a web content enrichment system 105, a search engine 110, one or more web resources 115, and one or more client devices 120. The elements of computer environment 100 are operatively connected to each other using one or more data networks 125.

The data network 125 can refer to any wired, wireless, or optical networks including, for example, the Internet, intranet, local area network (LAN), Personal Area Network (PAN), Wide Area Network (WAN), Virtual Private Network (VPN), cellular phone networks (e.g., Global System for Mobile (GSM) communications network, packet switching communications network, circuit switching communications network), Bluetooth radio, Ethernet network, an IEEE 802.11-based radio frequency network, a Frame Relay network, Internet Protocol (IP) communications network, or any other data communication network utilizing physical layers, link layer capability, or network layer to carry data packets, or any combinations of the above-listed data networks. In some embodiments, the data network 125 includes a corporate network, data center network, service provider network, mobile operator network, or any combinations thereof.

The communication between the elements of computer environment 100 can be based on one or more data communication sessions established and maintained using a number of protocols including, but not limited to, Internet Protocol (IP), Internet Control Message Protocol (ICMP), Simple Object Access Protocol (SOAP), Transmission Control Protocol (TCP), User Datagram Protocol (UDP), Hypertext Transfer Protocol (HTTP), Hypertext Transfer Protocol Secure (HTTPS), File Transfer Protocol (FTP), Transport Layer Security (TLS) protocol, Secure Sockets Layer (SSL) protocol, Internet Protocol Security (IPSec), Voice over IP (VoIP), secure video or audio streaming protocols, secure conferencing protocols, secure document access protocols, secure network access protocols, secure e-commerce protocols, secure business-to-business transaction protocols, secure financial transaction protocols, secure collaboration protocols, secure on-line game session protocols, and so forth.

The client devices 120 can refer to a mobile device, smartphone, tablet computer, personal computer, and the like. The client devices 120 are operated by users, for example, to access web content stored by the web resources 115 or perform searches of web content using the search engine 110. The search engine 110 can be any web service entity configured to index web content, such as webpages, and provide users of client devices 120 with lists of search results (also referred to as results lists) in response to receives search queries.

The web content enrichment system 105 is configured to perform the enrichment of web content, where the web content can refer to text of webpages or text of webpage snippets. The enrichment of web content is based on matching the text of web content to images using one or more machine-learning algorithms, machine-learning algorithms, probabilistic algorithms, heuristic algorithms, neural network algorithms, and the like. The operation of web content enrichment system 105 is provided below.

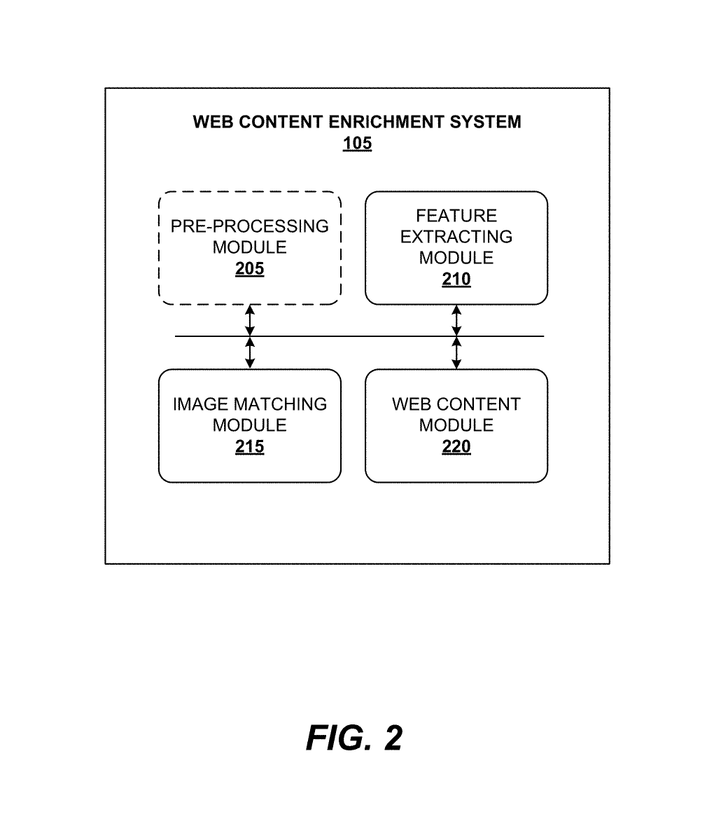

FIG. 2 shows a block diagram of web content enrichment system 105, according to one example embodiment. The web content enrichment system 105 can include an optional pre-processing module 205, a feature extracting module 210, an image matching module 215, and a web content module 220. The modules 205-220 are operatively connected to each other using one or more communication buses, input-output buses, data networks, or any other communication means, or any combinations thereof. It should be also understood that each of the modules 205-220 can include hardware components (e.g., one or more processors, memory, network interface, etc.), software components (e.g., one or more software or middleware applications, computer-readable code, or computer-readable instructions), or any combinations thereof.

The feature extracting module 205 can be configured to receive a plurality of images and a plurality of text documents, where none of the images are located in the text documents. The images and text documents can be received from the web resources 115 or pre-processing module 205. In some embodiments, the text documents are produced from web content (e.g., snippets are generated for webpages or texts are extracted from webpages).

The feature extracting module 205 can be also configured to extract image features from each of the images and extract text features from each of the text document. The image features for each of the images can be extracted from metadata of the images and directly from the images themselves using one or more machine-learning algorithms (such as a pre-trained neural network). In some embodiments, the feature extracting module 205 can perform object recognition of the images to produce one or more image features. In yet additional embodiments, the image features can be retrieved from additional webpages stored in the web resources 115, where the additional webpages differ from the web content taken for matching with the images.

The text features for each of the text documents can be extracted directly from the text document using one or more machine-learning algorithms (such as a pre-trained neural network) or from remote web resources 115. The text features can include one or more text attributes and one or more word embeddings. The text attributes can refer to statistical characteristics of text documents such as a word count, a term frequency parameter, a term frequency-inverse document frequency (tf-idf) parameter, and so forth. The text attributes can be obtained using one or more statistical modules. The word embeddings can include more sophisticated text features and semantic parameters or characteristics of the text documents obtained based on distributional semantic models. In certain embodiments, the word embeddings include vectors whose relative similarities correlate with semantic similarity of the terms in text documents. The word embeddings can be generated using one or more machine-learning algorithms, and, more particularly, one or more machine-learning algorithms.

The image matching module 215 can be configured to receive and use the image features and text images to match the plurality of images to the plurality of text documents such that a set of the images are matched for a select text document of the plurality of text documents, and also select a select image of the set of the images for the select text document of the plurality of text documents. The image matching module 215 can use one or more machine-learning algorithms, machine-learning algorithms, probabilistic models, cosine similarity model, and the like. Thus, each of text documents is matched by the image matching module 215 to one particular image, which is the best representation of its respective text document. In some embodiments, the process of matching can also be referred to as a classification process.

In certain embodiments, the matching process involves matching each text document to a certain set of images (e.g., 2, 3, 4, 5, 10, 50, 100 or more images), or vice versa, and then selecting one of these images based on its score such that the selected image best characterizes the text document. The scores can be calculated for each image based on the image features, the text features, or any combination thereof. In certain embodiments, a Gradient-Boosting Tree (GBT) model can be applied by the image matching module 215 to calculate the score of each image depending on one or more text documents using features from both the image and features from text document.

In some embodiments, the image matching module 215 can be further configured to obtain user experience feedback in response to delivering the enriched snipped or enriched text document. The user experience feedback can represent a measure of quality parameter. For example, a user can make an input, such as click a button on a graphical user interface, to denote that a particular image selected to enrich a snippet, text document or webpage is not relevant. In other embodiments, the user experience feedback can refer to any other user actions or lack of actions. When the user experience feedback is obtained, the image matching module 215 can train one or more machine-learning algorithms used for matching images to text documents.

Still referring to FIG. 2, the web content module 220 can be configured to enrich text documents, webpages, web content, snippets with selected images based on the output with image-to-text results from the image matching module 215.

For example, in one embodiment, the web content module 220 can crawl a plurality of webpages to produce (or retrieve) a plurality of text documents such as webpage descriptions, text incorporated into webpages, metadata of webpages, and the like. Furthermore, the web content module 220 produces (or retrieves) snippets of the plurality of webpages. Subsequently, the web content module 220 enriches the snippets of the plurality of webpages by attributing to or incorporating into the snippets respective images matched to corresponding text documents. In other embodiments, however, the web content module 220 can enrich text documents (e.g., webpages) directly by incorporating the matched images into the text documents or by associating the matched images to the text documents.

The optional pre-processing module 205 can pre-process the plurality of images or the plurality of text documents. In one example embodiment, the pre-processing module 205 can provide a first group of images obtained from the search engine 110 and a second group of images obtained randomly from one or more web resources 115. The first group of images and the second group of images can be combined together into a set of images that are later matched to a particular text document by the image matching module 215. The first group of images can include five images from the search engine 110, although any other number of images can be taken (e.g., 2, 3, 4, 5, 10, 50, 100, and so forth). The second group of images can include five random images from the web resources 115, although any other number of images can be taken (e.g., 2, 3, 4, 5, 10, 50, 100, and so forth). It was shown that five images from the search engine 110 and five other random images, when combined together, can unexpectedly provide fast and satisfactory text-to-image matching results at low costs (i.e., without using significant computational resources).

In some additional embodiments, the feature extracting module 205 can be also configured to receive a query image not associated with the plurality of images, extract query image features from the query image based on the plurality of images and the plurality of the text documents which were previously matched by the image matching module, and generate a search query for the search engine 110 based on the query image features. In this process, the query image features can be extracted similarly to the extraction process used for extracting the image features. The search engine 110 can then use the search query to produce a results list of web contents that are relevant to the search query, and thus relevant to the query image. This approach allows users of client devices 120 to send a query image (e.g., showing a piece of apparel) to the web content enrichment system 105 using a web service, and in return the web content enrichment system 105 (or the search engine 110) can provide to the user a title or brand of the piece of apparel depicted in the query image.

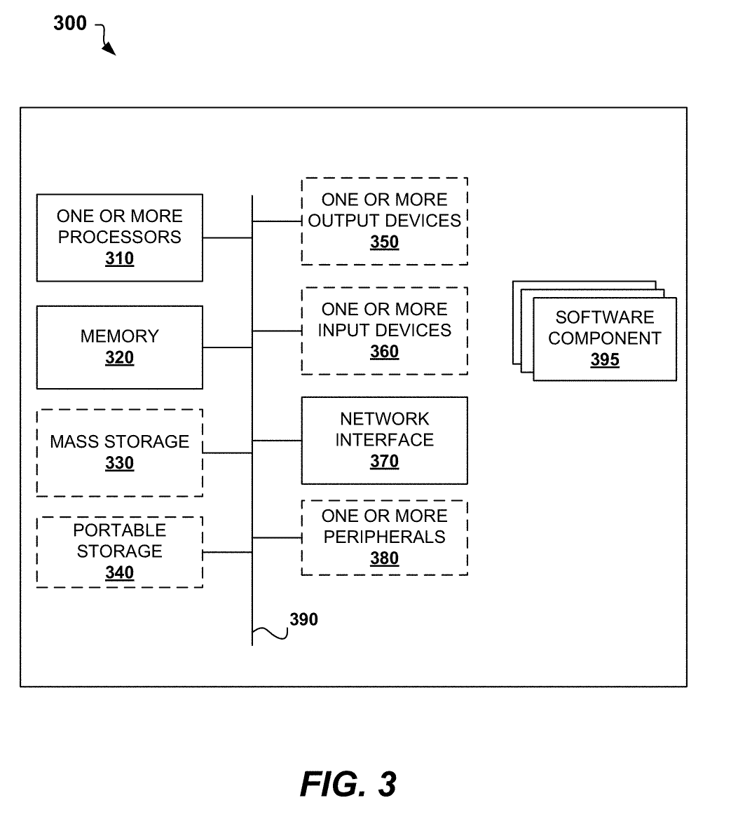

FIG. 3 illustrates an example computing system 300 that may be used to implement methods described herein. The computing system 300 may be implemented in the contexts of the likes of the web content enrichment system 105, search engine, 110, web resource 115, client device 120, pre-processing module 205, feature extracting module 210, image matching module 215, or web content module 220.

As shown in FIG. 3, the hardware components of the computing system 300 may include one or more processors 310 and memory 320. Memory 320 stores, in part, instructions and data for execution by processor 310. Memory 320 can store the executable code when the system 300 is in operation. The system 300 may further include an optional mass storage device 330, optional portable storage medium drive(s) 340, one or more optional output devices 350, one or more optional input devices 360, a network interface 370, and one or more optional peripheral devices 380. The computing system 300 can also include one or more software components 395.

The components shown in FIG. 3 are depicted as connected via a single bus 390. The components can be connected through one or more data transport means or data network. The processor 310 and memory 320 can be connected via a local microprocessor bus and the mass storage device 330, peripheral device(s) 380, portable storage device 340, and network interface 370 may be connected via one or more input/output (I/O) buses.

The mass storage device 330, which may be implemented with a magnetic disk drive, solid-state disk drive, or an optical disk drive, is a non-volatile storage device for storing data and instructions for use by the processor 310. Mass storage device 330 can store the system software (e.g., software components 395) for implementing embodiments described herein.

Portable storage medium drive(s) 340 operates in conjunction with a portable non-volatile storage medium, such as a compact disk (CD), or digital video disc (DVD), to input and output data and code to and from the computer system 300. The system software (e.g., software components 395) for implementing embodiments described herein may be stored on such a portable medium and input to the computer system 300 via the portable storage medium drive(s) 340.

The optional input devices 360 provide a portion of a user interface. The input devices 360 may include an alphanumeric keypad, such as a keyboard, for inputting alphanumeric and other information, or a pointing device, such as a mouse, a trackball, a stylus, or cursor direction keys. Additionally, the system 300 as shown in FIG. 3 includes optional output devices 350. Suitable output devices include speakers, printers, network interfaces, and monitors.

The network interface 370 can be utilized to communicate with external devices, external computing devices, servers, and networked systems via one or more communications networks such as one or more wired, wireless, or optical networks including, for example, the Internet, intranet, LAN, WAN, cellular phone networks, Bluetooth radio, and an IEEE 802.11-based radio frequency network, among others. The network interface 370 may be a network interface card, such as an Ethernet card, optical transceiver, radio frequency transceiver, or any other type of device that can send and receive information. The optional peripherals 380 may include any type of computer support device to add additional functionality to the computer system.

The components contained in the computer system 300 of FIG. 3 are those typically found in computer systems that may be suitable for use with embodiments described herein and are intended to represent a broad category of such computer components that are well known in the art. Thus, the computer system 300 can be a server, personal computer, hand-held computing device, telephone, mobile computing device, workstation, minicomputer, mainframe computer, network node, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium or processor-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a processor for execution. Such media can take many forms, including, but not limited to, non-volatile media, volatile media, and transmission media. Non-volatile media include, for example, optical or magnetic disks, such as a fixed disk. Volatile media include dynamic memory, such as system random access memory (RAM). Transmission media include coaxial cables, copper wire, and fiber optics, among others, including the wires that include one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, any other memory chip or cartridge, a carrier wave, or any other medium from which a computer can read.

Various forms of computer-readable media may be involved in carrying one or more sequences of one or more instructions to a processor for execution. A bus carries the data to system RAM, from which a processor retrieves and executes the instructions. The instructions received by system processor can optionally be stored on a fixed disk either before or after execution by a CPU.

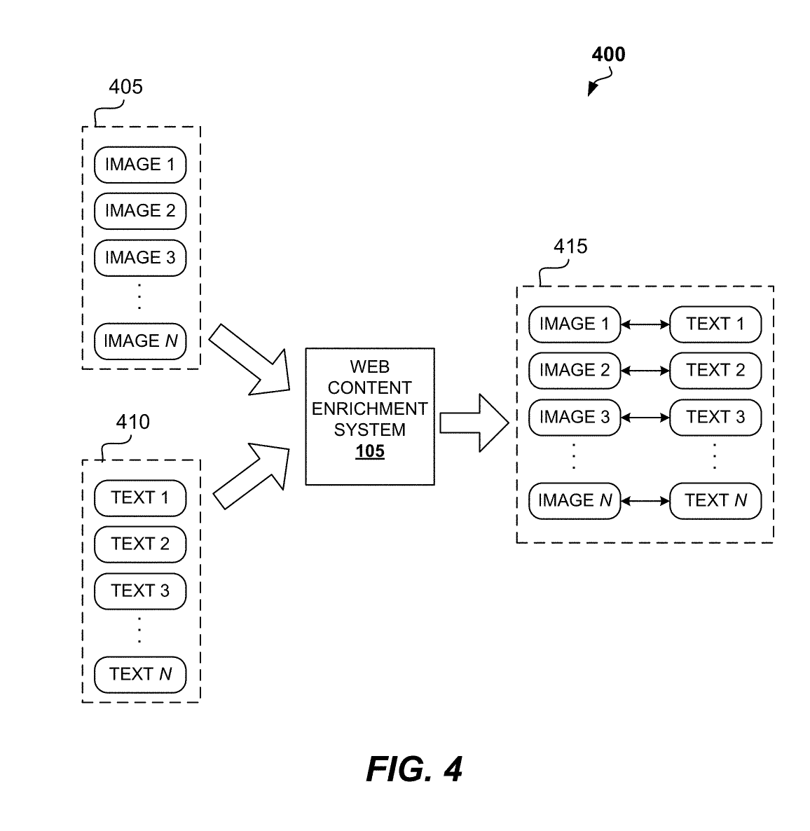

FIG. 4 shows an example process 400 for matching a plurality of images to a plurality of text documents (e.g., webpages or snippets of webpages), according to one example embodiment. The process 400 starts with obtaining a plurality of images 405 and a plurality of text documents 410 from web resources 115, search engine 110, client device 120, or data storage (e.g., a local memory of web content enrichment system 105). The plurality of images 405 and the plurality of text documents 410 are supplied to the feature extracting module 210, which extracts image features and text features. Furthermore, the image features and text features are supplied to the image matching module 215 for matching. A result of matching includes classification information 415, which includes the images matched, corresponded or associated to respective text documents as shown in FIG. 4.

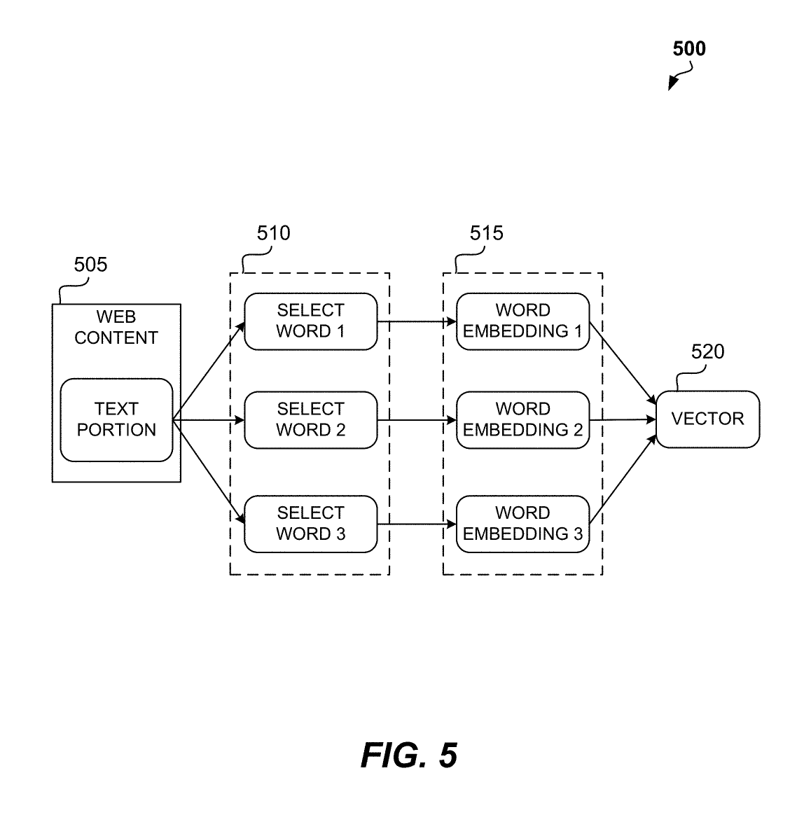

FIG. 5 shows an example process 500 for extracting text features from a text document, according to one example embodiment. The process 500 can commence with obtaining a text document 505 (e.g., a webpage, a snippet of webpage, web content) from the web resources 115, search engine 110, client device 120, or data storage (e.g., a local memory of web content enrichment system 105). The text document 505 can be supplied to the feature extracting module 210 for extraction of selected words (phrases) 510 from the text document 505 to produce word embeddings 515 (and optionally text attributes). The feature extracting module 210 then processes and combines word embeddings 515 (and optionally text attributes) into a single vector (feature vector) 520. The vector 520 can be used for matching to one or more images.

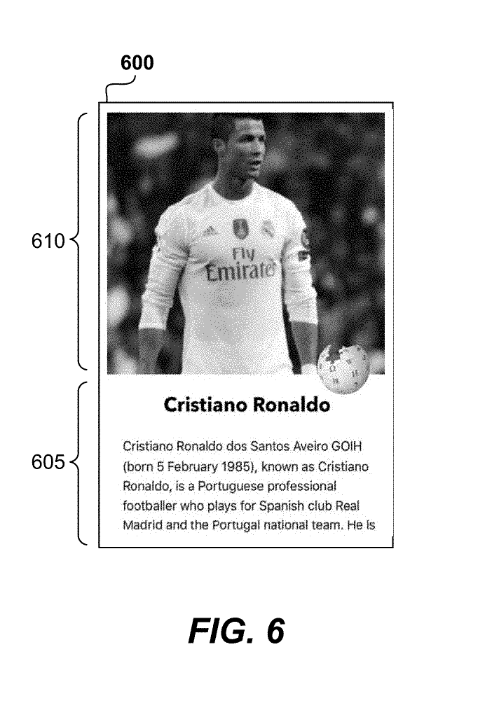

FIG. 6 shows an example snippet (webpage) 600 after enrichment, according to one example embodiment. More specifically, prior to the enrichment, the snippet (webpage) 600 included a text part 605 only. However, after enrichment, the enriched snippet (webpage) 600 includes both the text part 605 and an image 610, which was matched to the text part 605.

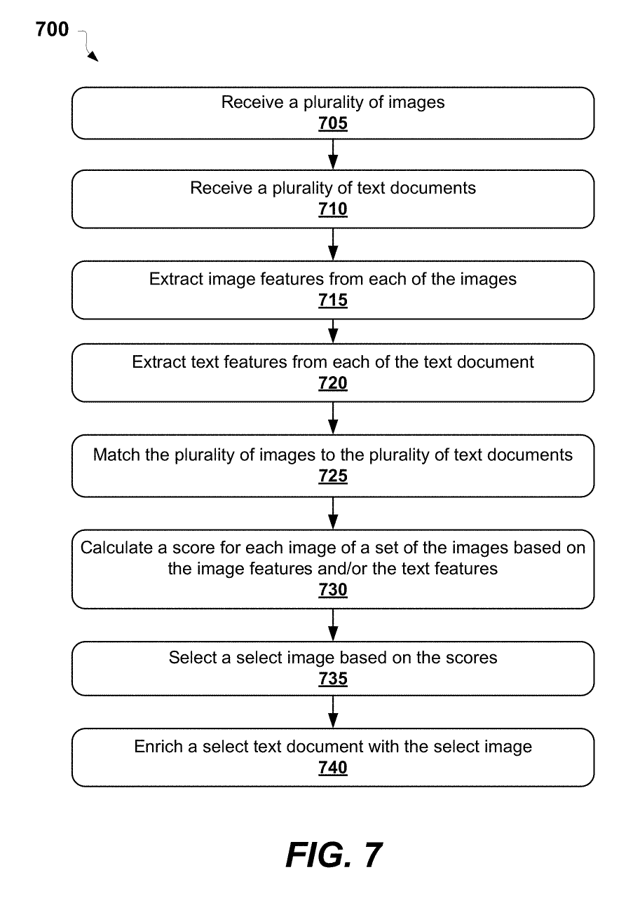

FIG. 7 is a process flow diagram showing a method 700 for web content enrichment according to an example embodiment. The method 700 may be performed by processing logic that may comprise hardware (e.g., decision-making logic, dedicated logic, programmable logic, application-specific integrated circuit (ASIC), and microcode), software (such as software run on a general-purpose computer system or a dedicated machine), or a combination of both. In one example embodiment, the processing logic refers to modules of web content enrichment system 105. Notably, below recited steps of the method 700 can be implemented in an order different than described and shown in the FIG. 7. Moreover, the method 700 may include additional steps not shown herein, but which can be evident to those skilled in the art from the present disclosure. The method 700 may also have fewer steps than outlined below and shown in FIG. 7.

The method 7 can commence at step 705 with the feature extracting module 210 receiving a plurality of images. In step 710, the feature extracting module 210 can receive a plurality of text documents, with none of the images located in the text documents.

In step 715, the feature extracting module 210 can extract image features from each of the images and, in step 720, extract text features from each text document. The image features for each of the images can be extracted from metadata of the images and the image itself using one or more machine-learning algorithms or optical recognition modules. The text features for each of the text documents can include text attributes obtained using one or more statistical module and word embeddings obtained using one or more machine-learning algorithms.

In step 725, the image matching module 215 matches the plurality of images to the plurality of text documents such that a set of the images are matched to a select text document taken from the plurality of text documents. The set of the images taken for the select text document can include a first group of images (e.g., five images) obtained from the search engine 110 and a second group of images (e.g., five images) obtained randomly from one or more web resources 115.

In step 730, the image matching module 215 calculates a score for each image of the set of the images based on the image features or the text features. In step 735, the image matching module 215 selects the select image based on the scores calculated for the set of images. The select image can be associated with the highest score, and thus it best represents the text document.

In step 740, the web content module 220 enriches the select text document with the select image. For example, the web content module 220 incorporates or associates the select text document to the select image. As discussed above, the web content module 220 can enrich a snippet of webpage by incorporating or associating the snippet to the select image.

Thus, methods and systems for web content enrichment using matching images to texts have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. A system for web content enrichment, the system comprising:
a memory storing a code executable by a feature extracting module, an image matching module, and a web content module;
the feature extracting module operable to:
receive a plurality of images by a feature extracting module;
receive a plurality of text documents, wherein none of the images are located in the text documents;
extract image features from each of the images at least by object recognition of each of the images; and
extract text features from each of the text document;
based on the image features of each of the images and the text features of each of the text document, an image matching module operatively connected to the feature extracting module, the image matching module being operable to:
match the plurality of images to the plurality of text documents such that a set of the images are matched for a select text document of the plurality of text documents; and
select a select image of the set of the images for the select text document of the plurality of text documents; and
a web content module operatively connected to the image matching module, the web content module being operable to enrich the select text document with the select image.

2. The system of claim 1, wherein the web content module is further operable to produce a snippet of a webpage, wherein the snippet of the webpage includes the select text document, a reference to the webpage, and the select image.

3. The system of claim 1, wherein the selecting, by the image matching module, the select image of the set of the images comprises:
calculating a score for each image of the set of the images by the image matching module; and
based on the scores of the set of the images, selecting the select image associated with the highest score.

4. The system of claim 3, wherein the calculating of the score for each age of the set of the images relies on both the image features and the text features.

5. The system of claim 1, wherein the image features for each of the images are extracted from metadata of the images and the image using one or more machine-learning algorithms.

6. The system of claim 1, wherein the text features for each of the text documents include text attributes obtained using one or more statistical modules and word embeddings obtained using one or more machine-learning algorithms.

7. The system of claim 1, wherein the set of the images taken for the select text document includes a first group of images obtained from a search engine and a second group of images obtained randomly from one or more web resources.

8. The system of claim 1, wherein the image matching module is further operable to:
obtain a user experience feedback by the image matching module in response to delivering the select text document enriched with the select image to a client device; and
train a machine-learning algorithm of the image matching module based on the user experience feedback.

9. The system of claim 1, wherein the feature extracting module is further operable to:
receive a query image not associated with the plurality of images;
extract query image features from the query image based on the plurality of images and the plurality of the text documents which were previously matched by the image matching module; and
generate a search query for a search engine based on the query image features.

10. A method for web content enrichment, the method comprising:
receiving a plurality of images by a feature extracting module;
receiving a plurality of text documents by the feature extracting module, wherein none of the images are located in the text documents;
extracting image features from each of the images by the feature extracting module at least by object recognition of each of the images;
extracting text features from each of the text document by the feature extracting module;
based on the image features of each of the images and the text features of each of the text document, matching the plurality of images to the plurality of text documents by an image matching module such that a set of the images is matched to a select text document of the plurality of text documents;
selecting, by the image matching module, a select image of the set of the images for the select text document of the plurality of text documents; and
enriching the select text document with the select image by a web content module.

11. The method of claim 10, wherein the enriching of the text document with the select image comprises creating a snippet of a webpage, wherein the snippet of the webpage includes the select text document, a reference to the webpage, and the select image.

12. The method of claim 10, wherein the selecting the select image of the set of the images comprising:
calculating a score for each image of the set of the images by the image matching module; and
based on the scores of the set of the images, selecting the select image associated with the highest score.

13. The method of claim 12, wherein the calculating of the score for each image of the set of the images relies on both the image features and the text features.

14. The method of claim 10, wherein the image features for each of the images are extracted from metadata of the images and the image using one or more machine-learning algorithms.

15. The method of claim 10, wherein the text features for each of the text documents include text attributes obtained using one or more statistical modules and word embeddings obtained using one or more machine-learning algorithms.

16. The method of claim 10, wherein the set of the images taken for the select text document includes a first group of images obtained from a search engine and a second group of images obtained randomly from one or more web resources.

17. The method of claim 10, further comprising:
obtaining a user experience feedback by the image matching module in response to delivering the select text document enriched with the select image to a client device; and
training the image matching module based on the user experience feedback, wherein the image matching module includes a machine-learning algorithm.

18. The method of claim 10, further comprising:
receiving a query image by the feature extracting module, the query image not being associated with the plurality of images;
extracting query image features from the query image by the feature extracting module based on the plurality of images and the plurality of text documents which were previously matched by the image matching module;
generating by the feature extracting module a search query for a search engine based on the query image features; and
causing the search engine to produce search results based on the search query.

19. The method of claim 10, further comprising:
crawling webpages by a web content enrichment system and producing the plurality of text documents associated with the webpages, wherein the webpages lack images associated with the text documents; and
producing, by the web content module, snippets of the webpages, wherein each of the snippets includes the select image and the select text document, which are both related to one of the webpages.

20. A non-transitory processor-readable medium having instructions stored thereon, which when executed by one or more processors, cause the one or more processors to implement a method for method for web content enrichment, the method comprising:
receiving a plurality of images by a feature extracting module;
receiving a plurality of text documents by the feature extracting module, wherein none of the images are located in the text documents;
extracting image features from each of the images by the feature extracting module at least by object recognition of each of the images;
extracting text features from each of the text document by the feature extracting module;
based on the image features of each of the images and the text features of each of the text document, matching the plurality of images to the plurality of text documents by an image matching module such that a set of the images is matched for a select text document of the plurality of text documents;
selecting, by the image matching module, a select image of the set of the images for the select text document of the plurality of text documents; and
enriching the select text document with the select image by a web content module.
